(19) United States
(12) Patent Application Publication
(10) Pub. No.: US 2023/0018650 A1
(43) Pub. Date: Jan. 19, 2023

(54) METHOD, SYSTEM AND APPARATUS FOR SUPPLYING A CONSUMER DEVICE WITH ELECTRICAL ENERGY

(71) Applicant: SMA Solar Technology AG, Niestetal (DE)

(72) Inventor: Markus Hopf, Espenau (DE)

(21) Appl. No.: 17/951,289

(22) Filed: Sep. 23, 2022

Related U.S. Application Data
(63) Continuation of application No. PCT/EP2021/055930, filed on Mar. 9, 2021.

(30) Foreign Application Priority Data
Mar. 23, 2020 (DE) 10 2020 107 852.8

(51) Int. Cl. B60L 53/10; B60L 53/53; B60L 53/51; H02J 7/34; H02J 1/10

(52) U.S. Cl. CPC B60L 53/11; B60L 53/53; B60L 53/51; H02J 7/342; H02J 1/102

(57) ABSTRACT

The disclosure relates to a method for supplying a consumer device with electrical energy from an industrial DC network. The method having includes establishing a connection between an energy storage and the industrial DC network and transferring electrical energy from the DC network to the energy storage. When the connection is established between the energy storage and the industrial DC network, a connection between the energy storage and the consumer device is disconnected and the consumer remains galvanically isolated from the industrial DC network. The method also includes establishing a connection between the consumer device and the energy storage and transferring electrical energy from the storage energy storage to the consumer device. When the connection is established between the consumer device and the energy storage, a connection between the energy storage and the industrial DC network is disconnected and the consumer device remains galvanically isolated from the industrial DC network. The disclosure also relates to a system and an apparatus for supplying a consumer device with electrical energy.

### CROSS REFERENCE TO RELATED APPLICATIONS

This application is a continuation of International Patent Application Number PCT/EP2021/055930, filed on Mar. 9, 2021, which claims priority to German Patent Application number 10 2020 107 852.8, filed on Mar. 23, 2020, and is hereby incorporated by reference in its entirety.

### FIELD

The disclosure relates to a method, a system and an apparatus for supplying a consumer with electrical energy from an industrial DC network.

### BACKGROUND

An industrial DC network is generally understood to mean a building installation for electrical energy supply, which is provided as a DC voltage infrastructure in addition or alternatively to a conventional AC voltage network. As a result, direct current can increasingly be used in many areas where conventional alternating current had to be used until now. As a result, losses in individual subnetworks may be decreased, for example. Examples include lighting systems, data centers and industrial applications, in particular partially or fully automated production and assembly plants.

Vehicles, for example, electric vehicles or hybrid vehicles, have electrical energy storage, for example, rechargeable batteries. Batteries used to drive the vehicle are also referred to as traction batteries or high-voltage batteries. The batteries may be charged with electrical power that is drawn from an energy supply network. A charging station via which electrical power can be exchanged between an energy supply network and a battery constitutes a consumer device during a charging process. Such charging of the vehicle batteries is desired, for example, in the production process after final assembly so that a largely fully charged vehicle is available at the end of the production process.

Charging can be carried out by means of direct current-direct current conversion (so-called “DC/DC charging”) if the energy supply network is a so-called industrial DC network, i.e., a DC voltage network for supplying direct current at the location of the industrial production of the vehicle. For this purpose, a direct voltage converter (DC/DC converter) is generally required to suitably match the voltage levels of the network and of the battery. Such DC/DC converters include, for example, a power electronic circuit that connects the inputs of the DC/DC converter, i.e., the industrial DC network, to the outputs of the DC/DC converter, i.e., the battery, in a clocked manner via power semiconductors.

There are DC/DC converters with galvanic isolation and without galvanic isolation. If no components that cause galvanic isolation are arranged in the power path between the network and the battery, for example, when a DC/DC converter without galvanic isolation is used, a substantially direct galvanic connection between the industrial DC network and the battery can occur at least temporarily.

Galvanic isolation, also called galvanic decoupling, is understood to mean the prevention of electrical conduction between two circuits, between which power or signals are to be exchanged. Electrical conduction is interrupted by electrically non-conductive coupling members. In the case of galvanic isolation, the electrical potentials are disconnected from one another, and the circuits are then potential-free with respect to one another. The galvanic isolation can at the same time be accompanied by a coupling in a non-electrical manner by the electrically non-conductive coupling members. Various components, such as transformers, capacitors, optocouplers, optical waveguides or relays, may be used as coupling members for power or signal transfer with galvanic isolation.

In certain situations, galvanic isolation is required between a DC network and a consumer device, for example, a battery, connected to the DC network. If a battery is to be charged as part of an electric vehicle from a DC network in the industrial environment, galvanic isolation may even be mandatory if defined as such in a standard. Conventional DC/DC converters may ensure galvanic isolation by having a transformer, for example. By means of such a transformer, galvanically isolating DC/DC converters are considerably more complex and more expensive than DC/DC actuators without a transformer; moreover, the additional costs increase disproportionately with increasing rated power. In order to charge batteries of electric vehicles with storage capacities in the range of a few dozens to a few hundreds of kilowatt hours, a charging power of several hundred kilowatts is required, and therefore the transformer represents a considerable cost factor in a galvanically isolating DC/DC converter of this power class.

The voltage levels of an industrial DC network may be different and vary, for example, between 48 . . . 380 . . . 750 V DC; in individual cases more than 1000 V DC are also possible. The voltage range of an industrial DC network can thus be in a similar voltage window to the DC charging voltage of electric vehicles or hybrid vehicles, the battery of which has, for example, a voltage between 300 . . . 800 V DC. The charging power can be a few hundred kilowatts and, in particular, can be between 100 kW and 500 kW for a rapid charge. In the case of these power levels, significant currents may occur in the event of a fault so that, during the charging of the vehicle, galvanic isolation between a DC network, via which charging is effected, and the vehicle, is often prescribed for safety reasons.

### SUMMARY

The disclosure is directed to improving energy and cost efficiency and/or safety when supplying a consumer with electrical energy from an industrial DC network.

A method for supplying a consumer device with electrical energy from an industrial DC network, in which the consumer device is galvanically isolated from the industrial DC network is disclosed.

The method comprises establishing a connection between an energy storage and the industrial DC network and transferring electrical energy from the industrial DC network into the energy storage. In addition, electrical energy can be transferred from the energy storage into the industrial DC network via the connection between the energy storage and the industrial DC network, for example, in order to support the industrial DC network. When establishing the connection between the energy storage and the industrial DC network, a possibly existing connection between the energy storage and the consumer device is disconnected, such that the consumer device remains galvanically isolated from the industrial DC network when the energy storage is connected to the industrial DC network.

The method also comprises establishing a connection between the consumer device and the energy storage and transferring electrical energy from the energy storage to the consumer device. When establishing the connection between the consumer device and the energy storage, a possibly existing connection between the energy storage and the industrial DC network is disconnected, such that the consumer device remains galvanically isolated from the industrial DC network.

In one embodiment, the two acts described above are carried out alternately so that the industrial DC network is connected alternately to the energy storage or to the consumer device, respectively. The state in which the industrial DC network is connected to the energy storage can, for example, be referred to as the first operating state. In the first operating state, the energy storage can be supplied with electrical energy and thus charged via the industrial DC network. It is also possible for the energy storage in the first operating state to support the industrial DC network by means of targeted feed-in of energy. In the first operating state, the consumer device is disconnected from the industrial DC network and remains galvanically isolated from the industrial DC network, for example, during the switching process as well.

The other state in which the consumer device is connected to the energy storage can, for example, be referred to as a second operating state. In the second operating state, the consumer device can be supplied with electrical energy by the energy storage. The energy storage and thus also the consumer device are disconnected from the industrial DC network.

The consumer device is thus disconnected from the industrial DC network in both operating states and remains so, for example, during the switching processes as well. The galvanic isolation is, for example, desirable when supplying consumers with high power, e.g., when charging a battery of a vehicle after final assembly, i.e., when the vehicle shall be fully charged via a charging connection while still at the factory after final assembly.

Such a method makes it possible to supply the consumer device with electrical energy from the industrial DC network, wherein the galvanic isolation between the consumer device and the industrial DC network can be ensured in a safe and cost-effective manner.

In one embodiment of the method, in the case of an existing connection between the energy storage and the industrial DC network, power is exchanged at a C-rate of less than one, for example, less than 0.5, with respect to the capacity C of the energy storage. In a further embodiment of the method, in the case of an existing connection between the energy storage and the consumer device, power is exchanged at a C-rate of less than one, for example, less than 0.5, with respect to the capacity of the energy storage. In the case of an existing connection between the energy storage and a battery of a vehicle assigned to the consumer device, power thereby flows from the energy storage to the consumer device at a C-rate of greater than one, for example, greater than two, with respect to the capacity of the battery of the vehicle. The C-rate describes the charging or discharging current of a battery, with respect to its capacity C. By limiting the charging and discharging power of the energy storage, excessive loading and rapid aging of the energy storage are prevented. In order to simultaneously enable rapid charging via the consumer device, which requires a high charge rate with respect to the capacity of the battery of the vehicle to be charged, the capacity of the energy storage must thus be greater by a factor of 2, for example, by a factor of 4, or, for example, by a factor of 10 than the capacity of the battery of the vehicle to be charged; the greater this factor is, the less the energy storage is loaded and the faster it can be charged.

A system with an industrial DC network, with at least one energy storage and with at least one consumer device has at least one apparatus with a DC/DC converter and a switching circuit or unit. A first interface of the DC/DC converter is connected to the energy storage, and a second interface of the DC/DC converter is connected to a first connection of the switching unit. In a first operating state, the first connection of the switching unit is connected to a second connection of the switching unit in order to connect the energy storage to the industrial DC network. In a second operating state, the first connection of the switching unit is connected to a third connection of the switching unit in order to connect the energy storage to the consumer.

By switching the connection of the energy storage between the industrial DC network and the consumer, it can cost-effectively be ensured that the consumer device remains galvanically isolated from the industrial DC network. This also applies, for example, during the switching process. As a result, it is possible for a DC/DC converter that does not have a galvanic isolation between its first connection and its second and third connection to be used in the apparatus. Thus, a DC/DC converter without a transformer can be used, for example. Such a DC/DC converter without galvanic isolation, i.e., without a transformer, can be embodied more cost-effectively than a DC/DC converter with galvanic isolation, i.e., with a transformer. A bidirectionally operable topology, for example, is used for the DC/DC converter so that the DC/DC converter can control the electrical power flow in both directions and can disconnect the current flow in both directions in the event of a fault. In a bidirectional embodiment, the DC/DC converter can also enable the charging of the energy storage by the industrial DC network on the one hand and the support of the industrial DC network by the energy storage on the other hand.

In one embodiment, the system has a controller that is configured to control the apparatus with a control signal, wherein the apparatus is configured to assume the first or the second operating state as a function of the control signal. In this case, the controller is, for example, connected to the apparatus via a data connection, which may be wireless or wired, and can transmit the control signal to the apparatus via the data connection. In one embodiment, the controller can be a component of the apparatus.

In one embodiment, the energy storage comprises a plurality of sub-storages. One apparatus and one consumer device can be assigned to each sub-storage so that the sub-storages may alternatively or cumulatively be connected to the industrial DC network or the assigned consumer device. Embodiments in which a plurality of sub-storages is assigned to one apparatus and one consumer device are also possible. Embodiments in which one apparatus is assigned to one sub-storage and a plurality of apparatuses is assigned to one consumer device are also possible. With such embodiments as well, the sub-storages may alternatively or cumulatively be connected to the industrial DC network or the consumer device or consumer devices.

In the case of the alternative connection of the sub-storages to the industrial DC, only one sub-storage is in each case connected to the industrial DC network or the assigned consumer device. As a result, some of the sub-storages may be charged via the industrial DC network while others of the sub-storages simultaneously or concurrently supply consumer devices with electrical energy. In the cumulative connection of the sub-storages to the industrial DC network, the sub-storages are simultaneously or concurrently connected to the industrial DC network or to the assigned consumer. As a result, it is possible to supply a plurality of consumers simultaneously with electrical energy. Mixed forms of cumulative and alternative connection are also possible so that the sub-storages are connected, for example, in groups to the industrial DC network or to the respective assigned consumer devices.

In one embodiment, the DC/DC converter of the apparatus has a rated power that is required to supply one or more consumer devices, for example, for charging one or more electric vehicles, at a C-rate, also called charge rate, of greater than one. In one embodiment, the DC/DC converter has a rated power of at least 50 kW, for example, at least 100 kW. The capacity of the energy storage is designed in such a way that the energy storage is discharged at a C-rate of less than one when electrical power is drawn at the level of the rated power of the DC/DC converter. In this case, it is possible for the energy storage to have a plurality of sub-storages that are connected to one apparatus or that are each connected to one apparatus. In one embodiment, a number of sub-storages can be so large that, during the charging of the connected consumer devices, a discharge rate<1 C arises in order to expose the sub-storages to only a low degree of cyclization in the medium charge-state range.

In one embodiment, the consumer device is a charging apparatus for charging a battery of a vehicle, for example, a high-voltage battery of an electric vehicle, having a capacity of greater than 50 kWh, for example, greater than 100 kWh. In such an embodiment, the rated power of the DC/DC converter is designed in such a way that the battery of the vehicle can be charged at a C-rate of greater than one.

The DC/DC converter can be connected via the switching device to exactly one charging station for charging exactly one electric vehicle. In a further embodiment, the system comprises, as further consumer devices, further charging apparatuses for charging further batteries of further vehicles, wherein the further charging apparatuses are, in one embodiment, connected in parallel with one another. Here, the DC/DC converter can be connected in parallel to a plurality of charging stations in order to charge a plurality of electric vehicles in parallel; although the vehicles are galvanically coupled to one another in this case, they are galvanically isolated from the industrial DC network. It is also possible to provide a plurality of apparatuses with a plurality of DC/DC converters, each of which can be connected to one charging apparatus.

In a further embodiment, the sub-storages of the energy storage may be divided and can be used in groups for buffering, maintenance charging and charging, in particular rapid charging after final assembly. During buffering, energy from the industrial DC network is temporarily stored, i.e., buffered, in the sub-storages. With maintenance charging, the sub-storages are used to maintain the charge of charged batteries of vehicles. During charging after final assembly, the batteries of the vehicles are charged in order to put them into a delivery-ready state.

For this purpose, the sub-storages may be divided into a plurality of groups, wherein at least one of the groups or also all of the groups each have an apparatus with a DC/DC converter. In one embodiment, a predominant part of the sub-storages is always coupled to the industrial DC network. At least one of the groups is temporarily “detached” as a group from the sub-storages by connecting the respective DC/DC converter via the switching unit to consumers connected thereto, i.e. to the charging stations, in order to directly charge electric vehicles via the charging stations. By means of the controller, which can be used as a superordinate operating control in one embodiment, the assignment of the sub-storages temporarily “detached” in this way can be changed if necessary, for example, if the charge state of the sub-storages currently used for charging reaches a lower threshold value. Such partially discharged sub-storages are subsequently recharged from the industrial DC network, wherein the recharging power provided to the sub-storages may be significantly lower than charging power for the rapid charging of the electric vehicles. As a result, the industrial DC network is spared from the high charging currents of the consumer devices, and load peaks in the industrial DC network are reduced. After final assembly, the vehicles, e.g., electric vehicles, may be charged in a manner galvanically isolated from the industrial DC network, and the result is a cost-effective solution with a reduction of the peak load.

In addition to the ensured required galvanic isolation, the system may also absorb high short-term peak power levels in one embodiment, which could represent a problem for the conventional infrastructure. The energy storage can be used as a buffer for reducing charging power peaks.

As an energy storage, for example, as a sub-storage of the energy storage, it is possible, for example, to use vehicle batteries, for example, high-voltage batteries, which are stored at the location of the system, for example, in the production plant, and are used later in the vehicles, for example. Such vehicle batteries not yet used in a vehicle may be kept at a medium charge state during storage in order to reduce aging. In one embodiment, only slight fluctuations should occur in a medium charge-state range; for example, these fluctuations should be accompanied by very low charge rates, for example, by charge rates<1 C.

If the energy storage comprises a large number of sub-storages with high capacity, these sub-storages may be used with low charge rates for buffering the industrial DC network and for reducing the load peaks, without being significantly loaded or excessively aged. This is advantageous when using vehicle batteries as sub-storages.

In one embodiment, an apparatus that is a component of a system described above has a DC/DC converter and a switching unit. A first interface of the DC/DC converter is configured to connect to an energy storage. A second interface of the DC/DC converter is connected to a first connection of the switching unit. A second connection of the switching unit is configured to connect to an industrial DC network. A third connection of the switching unit is configured to connect to a consumer device. In a first operating state, the first connection of the switching unit is connected to the second connection of the switching unit in order to thus establish a connection between the energy storage and the industrial DC network. In a second operating state, the first connection of the switching unit is connected to the third connection of the switching unit in order to thus establish a connection between the energy storage and the consumer device.

In one embodiment, the DC/DC converter is a DC/DC converter without galvanic isolation, for example, a DC/DC converter without a transformer. In one embodiment, the DC/DC converter can be operated bidirectionally. A bidirectionally operable DC/DC converter can control the current flow in both directions and, in the event of a fault, can disconnect it in both directions.

In one embodiment, the apparatus has a first operating state that enables the exchange of electrical energy between the energy storage and the industrial DC network. In the first operating state, for example, the charging of the energy storage from the industrial DC network and/or the stabilization of the industrial DC network is enabled by a power exchange with the energy storage. In one embodiment the apparatus further has a second operating state that enables the energy supply of the consumer device from the energy storage.

### BRIEF DESCRIPTION OF THE FIGURES

The disclosure is further explained and described below with reference to example embodiments illustrated in the figures.

FIG. 1 shows a system for supplying a consumer with electrical energy in a first embodiment;

FIG. 2 shows a system for supplying a consumer with electrical energy in a second embodiment; and

FIG. 3 shows acts of a method for supplying a consumer with electrical energy.

### DETAILED DESCRIPTION

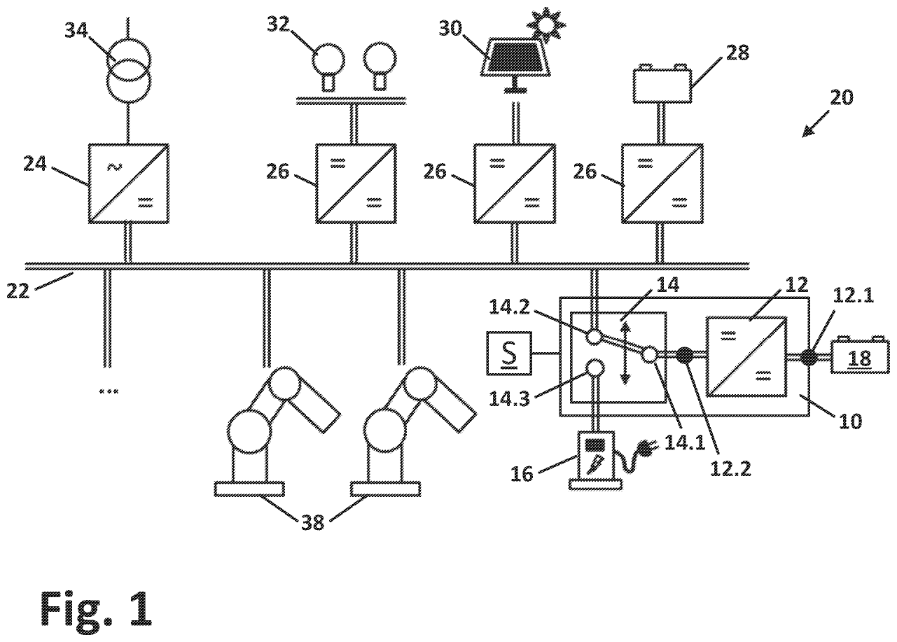

FIG. 1 shows a system 20 with an industrial DC network 22. The industrial DC network is connected via a rectifier 24 to an AC network 34, for example, a distribution network or transmission network of an energy supplier. The system 20 comprises devices connected to the industrial DC network 22 via DC/DC converters 26, such as lighting 32, robots 38, actuators, machines, air-conditioning units and the like. A photovoltaic system 30 is likewise connected via a DC/DC converter 26 to the industrial DC network 22 and feeds renewably generated electrical power into the industrial DC network 22. A plurality of energy storages is connected to the industrial DC network 22. An energy storage 18 is connected via an apparatus 10 to the industrial DC network 22, and an auxiliary storage 28 is connected via a DC/DC converter 26 to the industrial DC network 22. The energy storage 18 and the auxiliary storage 28 are used, inter alia, to temporarily store electrical energy and to cushion load peaks in the industrial DC network 22.

The apparatus 10 comprises a DC/DC converter 12 without a transformer and with a first interface 12.1, which is connected to the energy storage 18. The energy storage 18 can be divided into a plurality of sub-storages, or as a sub-storage can be part of a larger grouping, for example, a grouping of largely structurally identical energy storages 18.

The apparatus 10 further comprises a switching device 14 with a first connection 14.1, which is connected to the second interface 12.2 of the DC/DC converter 12. The switching device 14 is configured to connect the DC/DC converter 12 either to the industrial DC network 22 or to the consumer device 16. For this purpose, the switching device 14 has at least one contactor that, for example, can be a two-pole changeover contactor or a corresponding interconnection of a plurality of contactors.

In a first operating state BZ1, the first connection 14.1 of the switching unit 14 is connected to a second connection 14.2 of the switching unit 14 in order to connect the energy storage 18 to the industrial DC network 22. In a second operating state BZ2, the first connection 14.1 of the switching unit 14 is connected to a third connection 14.3 of the switching unit 14 in order to connect the energy storage 18 to the consumer device 16. In this case, the apparatus 10 is configured such that the consumer device 16 always remains galvanically isolated from the industrial DC network 22.

The consumer device 16, in one embodiment, comprises a charging station for batteries of electric vehicles and/or hybrid vehicles. The consumer device can also comprise a plurality of charging stations for batteries of electric vehicles and/or hybrid vehicles. This plurality of charging stations is then connected in parallel to the DC/DC converter 12 of the apparatus 10. As a result, a plurality of vehicles may be charged in parallel. Although these vehicles are then galvanically coupled to one another, they are in one embodiment galvanically isolated from the industrial DC network 22.

A controller S is configured to generate a control signal, by means of which the apparatus 10 is controlled, wherein the apparatus 10 is configured to assume the first operating state BZ1 or the second operating state BZ2 as a function of the control signal. In one embodiment, a superordinate operating control can interact with the controller S in order to integrate the operating states BZ1 and BZ2 of the apparatus 10 into the superordinate operating control.

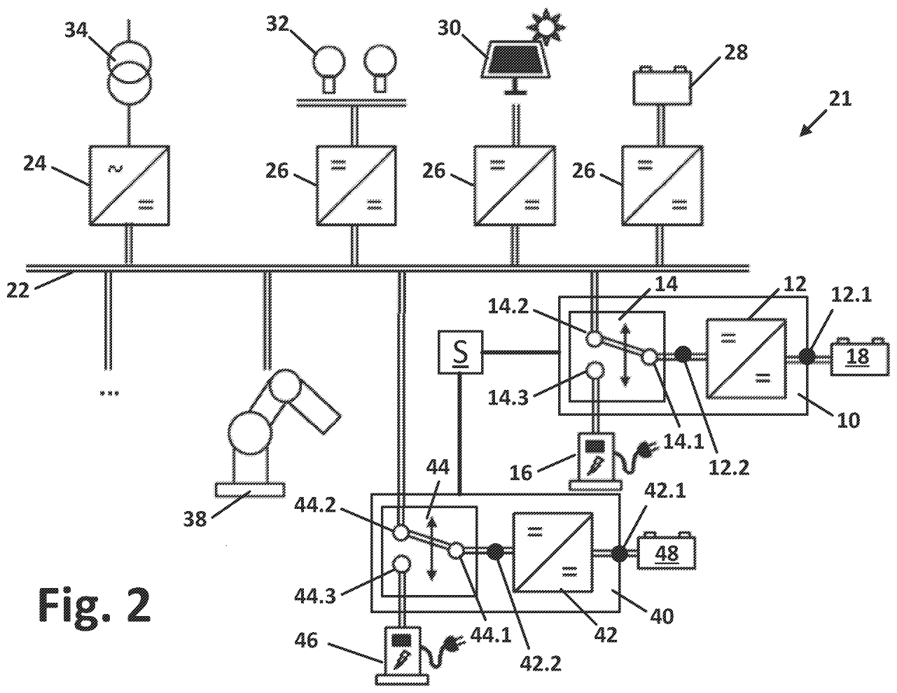

FIG. 2 shows a system 21 that is constructed like the system 20 of FIG. 1. In addition, the system 21 has a further energy storage 48, which is connected to the industrial DC network 22 via a further apparatus 40. The further energy storage 48 in one embodiment is divided into a plurality of sub-storages or, as a sub-storage, can be part of a larger grouping, for example, a grouping of largely structurally identical sub-storages, to which the energy storage 18 can also belong. A further consumer device 46 is also connected to the further apparatus 40. The further apparatus 40 is constructed like the apparatus 10 of FIG. 1 and, in addition to the apparatus 10, is connected to the industrial DC network 22. The further apparatus 40 has a further DC/DC converter 42, which is connected by means of a first interface 42.1 to the further energy storage 48. The further apparatus 40 further comprises a further switching device 44 with a first connection 44.1, which is connected to a second interface 42.2 of a further DC/DC converter 42. The further switching device 44 is configured to connect the further DC/DC converter 42 either to the industrial DC network 22 or to the further consumer device 46. For this purpose, the first connection 44.1 can be connected as required to the second connection 42.2 or the third connection 42.3 in order to connect the further energy storage 48 to the industrial DC network 22 or to the further consumer device 46 as required.

Analogous to the apparatus 10, the further apparatus 40 has the operating states BZ1 and BZ2. The controller S is configured to generate control signals both for the apparatus 10 and for the further apparatus 40 and thus to control the apparatuses 10 and 40 independently of one another and to operate them, in one embodiment, in a coordinated manner within the framework of a superordinate operating control. In this respect, the energy storage 18 and the further energy storage 48 may be considered as a sub-storage of a grouping that is connected to the industrial DC network via the further apparatus 40 disconnected from the apparatus 10 and is operated in a concerted manner by means of a suitable operating control.

In this embodiment, the energy storage 18 and 48 may be connected independently of one another via the apparatuses 10 and 40 either to the industrial DC network 22 or to the consumer device 16, 46. The energy storage 18, 48 coupled to the industrial DC network 22 is used, for example, as a buffer store for electrical energy of the industrial DC network 22 and can in turn contribute to the stabilization of the industrial DC network. The energy storage 18, 48 connected to the consumer device 16, 46 can be used for supplying energy to the consumer device 16, 46, i.e., for example, in order to charge batteries of vehicles after final assembly. In one embodiment, the assignment to the operating states BZ1, BZ2 can be changed flexibly via the controller S and/or the superordinate operating control, for example, when the charge state of the energy storage 18, 48 currently used for charging reaches a lower threshold value. Such partially discharged energy storages 18, 48 may subsequently be charged from the industrial DC network 22 with a charging power that is significantly lower than the charging power of the vehicles to be charged. As a result, the industrial DC network 22 is not loaded by the high charging currents of the vehicles, and load peaks in the industrial DC network 22 are reduced.

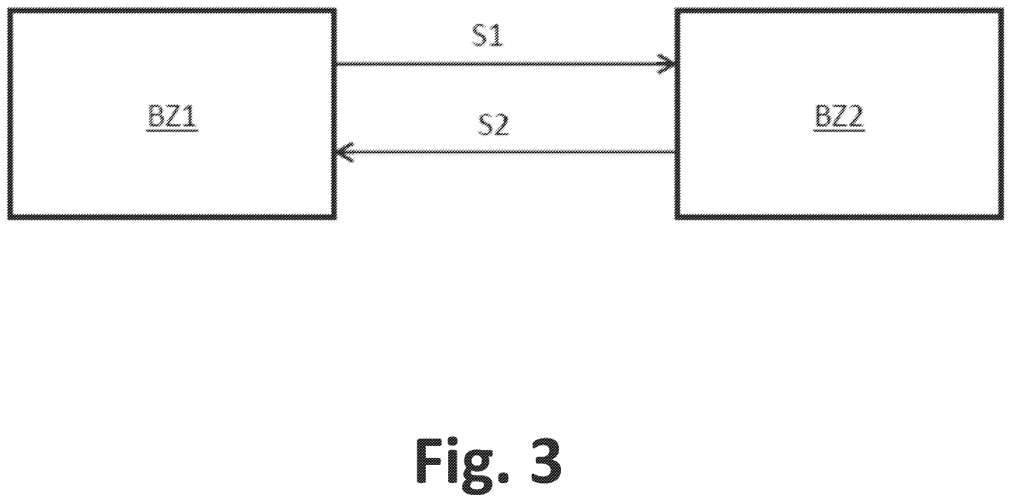

FIG. 3 shows acts S1 and S2 of a method for supplying a consumer device with electrical energy, which transfer an apparatus 10, 40 of a system 20, 21 from a first operating state BZ1 into a second operating state BZ2.

At S1, a connection is established between an energy storage 18, 48 and the industrial DC network 22, and the possibility of exchanging electrical energy between the industrial DC network 22 and the energy storage 18, 48 is created. This exchange of electrical energy comprises the transfer of electrical energy from the industrial DC network 22 to the energy storage 18, 48 and vice versa. In order to charge the energy storage 18, 48, electrical energy is transferred from the DC network 22 into the energy storage. The electrical power thereby transferred can, for example, be varied for supporting the industrial DC network 22 and optionally reversed, in order to feed it from the energy storage 18, 48 into the industrial DC network 22 as required. The connection between the DC network 22 and the energy storage 18, 48 is, for example, created in order to charge the energy storage 18, 48 and/or to feed a maintenance charge to the energy storage 18, 48 in order to prevent premature aging. When establishing the connection between the energy storage 18, 48 and the industrial DC network 22, a possibly existing connection between the energy storage 18, 48 and the consumer device 16, 46 is disconnected. The consumer device 16, 46 remains galvanically isolated from the industrial DC network 22.

By means of act S1, the apparatus 10, 40 is transferred from the first operating state BZ1 to the second operating state BZ2.

At S2, a connection is established between the consumer device 16, 46 and the energy storage 18, 48, and electrical power is transferred from the energy storage 18, 48 to the consumer device 16, 46, for example, in order to feed electrical energy via a charging station as a consumer device into a battery of a vehicle. In one embodiment, when the connection is being established between the consumer device 16, 46 and the energy storage 18, 48, a connection between the energy storage 18, 48 and the industrial DC network 22 is disconnected and the consumer device 16, 46 remains galvanically isolated from the industrial DC network 22.

By means of act S2, the apparatus 10, 40 is transferred from the second operating state BZ2 to the first operating state BZ1.

1. A method for supplying a consumer device with electrical energy from an industrial DC network, wherein the consumer device is galvanically isolated from the industrial DC network, the method comprising:
establishing a connection between an energy storage and the industrial DC network and transferring electrical energy from the industrial DC network into the energy storage, wherein, when the connection is being established between the energy storage and the industrial DC network, a connection between the energy storage and the consumer device is disconnected and the consumer device remains galvanically isolated from the industrial DC network; and
establishing a connection between the consumer device and the energy storage and transferring electrical energy from the energy storage to the consumer device, wherein, when the connection is being established between the consumer device and the energy storage, a connection between the energy storage and the industrial DC network is disconnected and the consumer device remains galvanically isolated from the industrial DC network.

2. The method according to claim 1, wherein, in a case of an existing connection between the energy storage and the industrial DC network or between the energy storage and the consumer device, a power is exchanged at a C-rate of less than one with respect to a capacity of the energy storage, and/or in a case of an existing connection between the energy storage and a battery of a vehicle assigned to the consumer device, a power flows from the energy storage to the consumer device at a C-rate of greater than one with respect to a capacity of the battery of the vehicle.

3. A system comprising an industrial DC network, at least one energy storage, at least one consumer device and at least one apparatus,
wherein the apparatus is configured to:
establish a connection between an energy storage and the industrial DC network and transferring electrical energy from the industrial DC network into the energy storage, wherein, when the connection is being established between the energy storage and the industrial DC network, a connection between the energy storage and the consumer device is disconnected and the consumer device remains galvanically isolated from the industrial DC network; and
establish a connection between the consumer device and the energy storage and transferring electrical energy from the energy storage to the consumer device, wherein, when the connection is being established between the consumer device and the energy storage, a connection between the energy storage and the industrial DC network is disconnected and the consumer device remains galvanically isolated from the industrial DC network,
wherein the apparatus comprises a DC/DC converter and a switching unit,
wherein a first interface of the DC/DC converter is connected to the energy storage, and a second interface of the DC/DC converter is connected to a first connection of the switching unit,
wherein the first connection of the switching unit in a first operating state is connected to a second connection of the switching unit to connect the energy storage to the industrial DC network, and wherein the first connection of the switching unit in a second operating state is connected to a third connection of the switching unit to connect the energy storage to the consumer device.

4. The system according to claim 3, further comprising a controller configured to control the apparatus with a control signal, wherein the apparatus is configured to assume the first operating state or the second operating state as a function of the control signal.

5. The system according to claim 3, wherein the energy storage comprises a plurality of sub-storages, the apparatus comprises a plurality of apparatuses, and the consumer device comprises a plurality of consumer devices, wherein each apparatus and consumer device is assigned to each sub-storage, respectively, so that the sub-storages are alternately or cumulatively connected to the industrial DC network.

6. The system according to claim 3, wherein the DC/DC converter has a rated power of at least 50 kW, and wherein a capacity of the energy storage is configured so that the energy storage is discharged at a C-rate of less than one when electrical power is drawn at a level of the rated power of the DC/DC converter.

7. The system according to claim 3, characterized in that the consumer is a charging apparatus for charging a battery of a vehicle, in particular a high-voltage battery of a vehicle having a capacity of greater than 50 kWh, preferably greater than 100 kWh.

8. The system according to claim 7, wherein a rated power of the DC/DC converter is configured so that the battery of the vehicle can be charged at a C-rate of greater than 1.

9. The system according to claim 7, further comprising further charging apparatuses configured to charge further batteries of further vehicles, wherein the further charging apparatuses are connected in parallel with one another.

10. An apparatus, comprising:
a DC/DC converter; and
a switching unit,
wherein a first interface of the DC/DC converter is configured to connect to an energy storage, and a second interface of the DC/DC converter is connected to a first connection of the switching unit,
wherein a second connection of the switching unit is configured to connect to an industrial DC network, and a third connection of the switching unit is configured to connect to a consumer device,
wherein the first connection of the switching unit in a first operating state is connected to the second connection of the switching unit to establish a connection between the energy storage and the industrial DC network, and wherein the first connection of the switching unit in a second operating state is connected to the third connection of the switching unit to establish a connection between the energy storage and the consumer device.

11. The apparatus according to claim 10, wherein the DC/DC converter comprises a DC/DC converter without galvanic isolation.

12. The apparatus according to claim 10, wherein the DC/DC converter comprises a bidirectional converter.

13. The apparatus according to claim 10, wherein, in the first operating state, the apparatus is configured to enable the exchange of electrical energy between the energy storage and the industrial DC network, wherein the charging of the energy storage from the industrial DC network and/or a stabilization of the industrial DC network is enabled by a power exchange with the energy storage.

14. The apparatus according to claim 10, wherein the apparatus in the second operating state is configured to enable the energy supply to the consumer device from the energy storage.
